(19) United States
(12) Patent Application Publication
(10) Pub. No.: US 2010/0000996 A1
(43) Pub. Date: Jan. 7, 2010

(54) CLOSURE OF VESSEL AND PROCESS FOR MANUFACTURING SAME

(76) Inventor: Hee Kwon Rho, Yongin (KR)

Correspondence Address: CANTOR COLBURN, LLP, 20 Church Street, 22nd Floor, Hartford, CT, 06103, US

(21) Appl. No.: 12/094,247

(22) PCT Filed: Nov. 17, 2006
(86) PCT No.: PCT/KR2006/004852

§ 371 Date: Nov. 11, 2008

(30) Foreign Application Priority Data
Nov. 18, 2005 (KR) 10-2005-0111005

(51) Int. Cl. B65D 51/18; B65D 41/50; B23P 11/00

(52) U.S. Cl. 220/254.8; 220/258.3; 220/258.4; 29/428

(57) ABSTRACT

A closure of a vessel, comprises: a body mounted at a vessel inlet through which stuff contained in a vessel is outwardly discharged; a sealing member removing unit formed in the body, for removing a sealing member sealed at a vessel inlet when the body is separated from the vessel inlet, and storing the removed sealing member in the body; and a reinforcing member having a sealing member bonded thereto at the time of an induction manufacturing process, for storing the sealing member in the closure. The closure is manufactured by an induction process so that the sealing member bonded to the vessel inlet can be stored in the closure.

### TECHNICAL FIELD

The present invention relates to a closure of a vessel for opening and closing a vessel inlet and a process for manufacturing the same, and more particularly, to a closure of a vessel capable of separating a sealing member sealing a vessel inlet from the vessel inlet together with a closure by cutting when the closure is opened.

### BACKGROUND ART

FIG. 1 is a sectional view showing a closure of a vessel in accordance with the conventional art.

Generally, a beverage vessel for storing beverage such as lactobacilus drink, a drug vessel for storing drug, or an oil vessel for storing oil is provided with a sealing member 114 for preventing stuff contained in the vessel 104 from being leaked out.

The sealing member 114 is mounted at a vessel inlet 102 by thermal bonding, etc., thereby sealing stuff contained in the vessel 104. A closure 100 for preventing the sealing member 114 from being damaged due to an external impact or a contact between objects is mounted on the vessel inlet 102.

The closure 100 is provided with a mounting unit for detachably mounting the closure 100 to the vessel inlet 102. The mounting unit includes a locking rib 108 protruding from an outer circumferential surface of the vessel inlet 102 as a ring shape in a circumferential direction, and a locking jaw 110 protruding from an inner circumferential surface of the closure 100 as a ring shape in a circumferential direction, and locked by the locking rib 108.

A handgrip 112 held by a hand at the time of separating the closure 100 from the vessel inlet 102 is formed at the closure 100.

When the handgrip 112 is pulled by a user's hand, the locking jaw 110 formed at the closure 100 is detached from the locking rib 108, and thus the closure 100 is separated from the vessel inlet 102. Then, the sealing member 114 is removed from the vessel inlet 102, and stuff contained in the vessel is discharged out through the vessel inlet 102.

However, the conventional closure of a vessel has the following problems. That is, after separating the closure from the vessel, a user should remove the sealing member bonded to the vessel inlet by using his hand or by using an additional tool such as knife. Accordingly, there is inconvenience in using the conventional closure.

Furthermore, when the user removes the sealing member by using his hand, the sealing member is not smoothly separated from an edge of the vessel inlet due to a strong bonding force therebetween. Accordingly, the user has to remove the sealing member again with using his hand, thereby causing a sanitary problem.

### DISCLOSURE OF INVENTION

### Technical Problem

Therefore, it is an object of the present invention to provide a closure of a vessel capable of enhancing a user's convenience by forming a sealing member removing unit integrally with a closure, in which an additional member for removing sealing member is not required since the sealing member is automatically removed when the closure is opened.

Another object of the present invention to provide a closure of a vessel capable of solving a sanitary problem caused when a user contacts a vessel inlet by his hand so as to remove a sealing member by automatically removing a sealing member by a sealing member removing unit.

Still another object of the present invention to provide a closure of a vessel capable of storing a sealing member bonded to a vessel inlet in a closure by manufacturing the closure in which a sealing member removing unit is installed by an induction process.

Yet still another object of the present invention to provide a closure of a vessel capable of preventing interference between closures by a sealing member removing unit installed at the closure when the closure is mounted at the vessel.

### Technical Solution

To achieve these objects, there is provided a closure of a vessel, comprising: a body mounted at a vessel inlet through which stuff contained in the vessel is discharged out; a sealing member removing unit formed in the body, for removing a sealing member sealing the vessel inlet when the body is separated from the vessel inlet, and storing the removed sealing member in the body; and a reinforcing member having the sealing member attached thereto at the time of an induction manufacturing process, for storing the sealing member in the closure.

The sealing member removing unit may include: a pressing plate disposed in the body, the pressing plate movable in upper and lower directions; at least one cutter formed at an edge of a lower surface of the pressing plate in a circumferential direction, for penetrating the sealing member when the pressing plate is pressed, and for cutting the sealing member when the body is rotated; a locking unit downwardly protruding from a lower surface of the pressing plate, for storing the sealing member cut by the cutter in the body; and a connecting unit connecting an outer circumferential surface of the pressing plate with an inner circumferential surface of the body, and elastically transformable so that the pressing plate can move in upper and lower directions.

The reinforcing member may be formed to have a circular flat shape, and may be formed with a first through hole for passing the locking unit at a center thereof, and second through hole of the same number of the cutter for passing the cutter at a circumference thereof.

The reinforcing member may be provided with a notch portion having a narrow area at a connection portion between the second through holes so as to be easily cut by the cutter.

The reinforcing member may be formed as a circular ring shape, and be attached to an edge of the sealing member.

Adhesive melting at a low temperature may be deposited on one surface of the sealing member, and adhesive melting at a high temperature is deposited on the other surface of the sealing member.

The pressing plate may be formed on a part of an upper surface of the body, and may be formed to be eccentric from the center of the upper surface of the body.

To achieve these objects, there is also provided a process for manufacturing a closure of a vessel, comprising: depositing adhesives melting at different temperatures on the respective surfaces of a sealing member; attaching the sealing member to a reinforcing member at a low temperature; mounting the reinforcing member to which the sealing member has been attached in a closure; mounting the closure at a vessel inlet; and heating the closure with a high temperature, and thus attaching the sealing member to the vessel inlet.

### Advantageous Effects

The closure of a vessel according to the present invention has the advantageous effect in that since the sealing member removing unit is installed in the closure, automatically removed from the vessel inlet, and stored in the closure when the pressing plate of the sealing member removing unit is pressed before opening the closure, thereby enhancing the user's convenience.

Also the closure of a vessel according to the present invention has the advantageous effect in that since the sealing member is automatically removed by the sealing member removing unit, a sanitary problem caused when the user contacts the vessel inlet by hand in order to remove the sealing member is solved.

Also the closure of a vessel according to the present invention has the advantageous effect in that when the closure is mounted at the vessel by an induction process, the sealing member is attached to the reinforcing member disposed in the closure and the closure having the sealing member removing unit can be mounted at the vessel by an induction process.

### BRIEF DESCRIPTION OF THE DRAWINGS

FIG. 1 is a sectional view showing a closure of a vessel in accordance with the conventional art;

FIG. 2 is a disassembled perspective view showing a closure of a vessel according to the present invention;

FIG. 3 is a sectional view showing the closure of a vessel according to the present invention;

FIG. 4 is a perspective view showing a cutter according to the present invention;

FIG. 5 is a perspective view showing a locking unit according to the present invention;

FIG. 6 is an enlarged view showing a part of ‘A’ in FIG. 3;

FIG. 7 is a flow chart showing a process for manufacturing a closure of a vessel according to the present invention;

FIGS. 8 and 9 are views showing an operation state of the closure of a vessel according to the present invention;

FIG. 10 is a perspective view showing a reinforcing member according to a second embodiment of the present invention;

FIG. 11 is a perspective view showing a reinforcing member according to a third embodiment of the present invention; and

FIG. 12 is a perspective view showing a reinforcing member according to a fourth embodiment of the present invention.

### MODE FOR THE INVENTION

Hereinafter, a closure of a vessel according to the present invention will be explained with reference to the attached drawings.

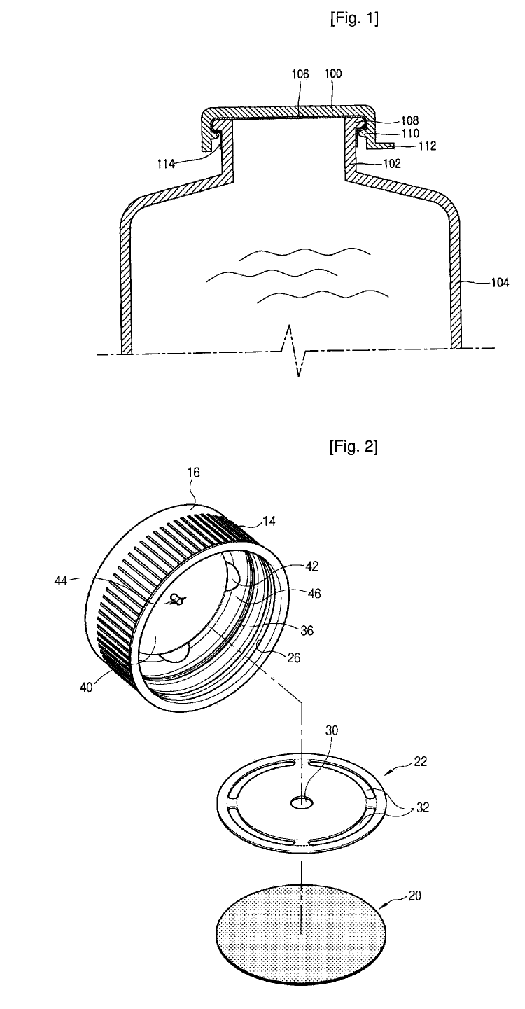

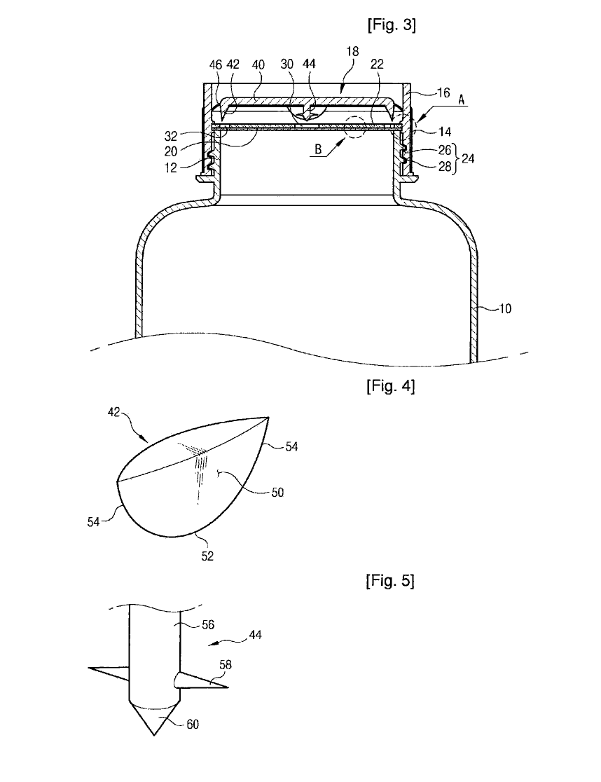

FIG. 2 is a disassembled perspective view showing a closure of a vessel according to the present invention, and FIG. 3 is a sectional view showing the closure of a vessel according to the present invention.

The closure of a vessel according to the present invention includes a body 16 having an inner space, and mounted at a vessel inlet 12 through which stuff contained in a vessel 10 is discharged out; a sealing member removing unit 18 formed in the body 16, for removing a sealing member 20 sealing the vessel inlet 12 when a closure 2 is separated from the vessel inlet 12, and storing the removed sealing member 20 in the closure 2; and a reinforcing member 22 for reinforcing strength of the sealing member 20 so that a stored state of the sealing member 20 inside the closure manufactured by an induction process can be maintained.

The vessel 10 is applied to a beverage vessel, a drug vessel, an oil vessel, etc. for storing stuff of a liquid state or a solid state therein. The sealing member 20 for sealing the vessel inlet 12 and thus protecting the stuff contained in the vessel 10 is attached to the vessel inlet 12. The sealing member 20 is made of paper or aluminum in multilayers, and a material that can be easily removed by a knife, etc.

The body 16 has a cylindrical shape, and a plurality of concave-convex protrusions 14 for facilitating opening of the closure 2 by the user's hand are formed at an outer circumferential surface of the body 16. A sealing member removing unit 18 is integrally formed in the body 16 by a molding process, and the reinforcing member 22 to which the sealing member 20 has been attached is fittedly-coupled into the body 16.

A mounting unit 24 is disposed at a lower portion of the body 16 so as to be detachably mounted to the vessel inlet 12.

The mounting unit 24 includes a female screw portion 28 formed at an inner circumferential surface of a lower end of the body 16, and a male screw portion 26 formed at an outer circumferential surface of the vessel inlet 12 and screw-coupled to the male screw portion 28.

The mounting unit 24 may have any structure to be detachably coupled between the body 16 and the vessel inlet 12.

The sealing member removing unit 18 includes: a pressing plate 40 disposed in the body 16 so as to be movable in upper and lower directions; at least one cutter formed at an edge of a lower surface of the pressing plate 40 in a circumferential direction with the same interval therebetween, for penetrating the sealing member 20 when the pressing plate 40 is pressed, and for cutting the sealing member 20 when the body 16 is rotated; a locking unit 44 downwardly protruding from a lower surface of the pressing plate 40, for locking the sealing member 20 so that the sealing member 20 cut by the cuter 42 can be stored in the body 16; and a connecting unit 46 connecting an outer circumferential surface of the pressing plate 40 with an inner circumferential surface of the body 16, for guiding the pressing plate 40 to move in upper and lower directions and supporting a moved position of the pressing plate 40 by its own elastic force.

The pressing plate 40 is formed in a disc shape having a diameter smaller than an inner diameter of the body 16, and is disposed preferably at a position lower than an upper surface of the body 16. A cover (not shown) may be mounted at an upper surface of the body 16, thereby protecting the body 16 from the pressing plate 40.

As shown in FIG. 4, the cutter 42 includes a plurality of supporting portions 50 disposed at an edge of a lower surface of the pressing plate 40 with regular interval therebetween; a first cutting portion 52 sharply disposed at a lower end of the supporting portion 50, for penetrating the sealing member 20 by being downwardly moved when the pressing plate 40 is pressed; and a second cutting portion 54 formed on at least one of two sides of the supporting portion 50, and rotated with a contacted state to an inner circumferential surface of the vessel inlet 12 when the body 16 is rotated, thereby cutting the sealing member 20 as a circular shape.

The connecting unit 46 is formed as a dome-shaped thin film for connecting an inner circumferential surface of the body 16 to an outer circumferential surface of the pressing plate 40. The connecting unit 46 is elastically transformed when the pressing plate 40 is pressed, thereby guiding the pressing plate 40 so as to be downwardly moved.

The connecting unit 46 elastically maintains a current position of the pressing plate 40. More concretely, when the pressing plate 40 is upwardly protruding without being pressed, the connecting unit 46 maintains the current position of the pressing plate 40 by maintaining a dome shape. On the contrary, when the pressing plate 40 is pressed, the connecting unit 46 is elastically transformed as a concave shape thereby to maintain the pressed position of the pressing plate 40.

As shown in FIG. 5, the locking unit 44 includes a supporting rod 56 downwardly extending from the center of a lower surface of the pressing plate 40, for penetrating the sealing member 20 when the pressing plate 40 is pressed; and at least one locking rod 58 formed at an outer circumferential surface of a lower portion of the supporting rod 56, for locking the sealing member 20 so that the sealing member 20 cut by the cutter 42 can be stored in the body 16.

The supporting rod 56 is formed as a cylindrical bar downwardly and perpendicularly extending from the center of the pressing plate 40. A punch portion 60 having a sharp shape for penetrating the sealing member 20 is formed at the end of the supporting rod 56.

The locking rod 58 is formed so as to be elastically transformed in an upper direction. At the time of penetrating the sealing member 20, the locking rod 58 is upwardly bent thus to penetrate the sealing member 20 through a hole formed by the punch portion 60. After the locking rod 58 penetrates the sealing member 20, it is restored into the original state thus to be locked at an inner surface of the sealing member 20.

The reinforcing member 22 is formed to have a disc shape having a certain strength. The reinforcing member 22 includes a first through hole 30 for passing the locking unit 44 at a center thereof, and second through hole 32 of the same number with the cutters 42 for passing the cutter 42 at a circumference thereof. As shown in FIG. 1, a knife line or a plurality of cut grooves for facilitating a cutting are formed between the second through holes 32.

The reinforcing member 22 is fitted into a locking groove 36 having an edge formed at an inner circumferential surface of the body 16, thereby being prevented from being outwardly separated from the vessel.

When the closure manufactured by an induction process is mounted at the vessel inlet 12, the sealing member 20 has to be stored in the closure with a attached state to the surface of the reinforcing member 22. The reinforcing member 22 may be made of any material such as synthetic resin or paper having an strength enough for the sealing member 20 to be stored in the closure with a attached state.

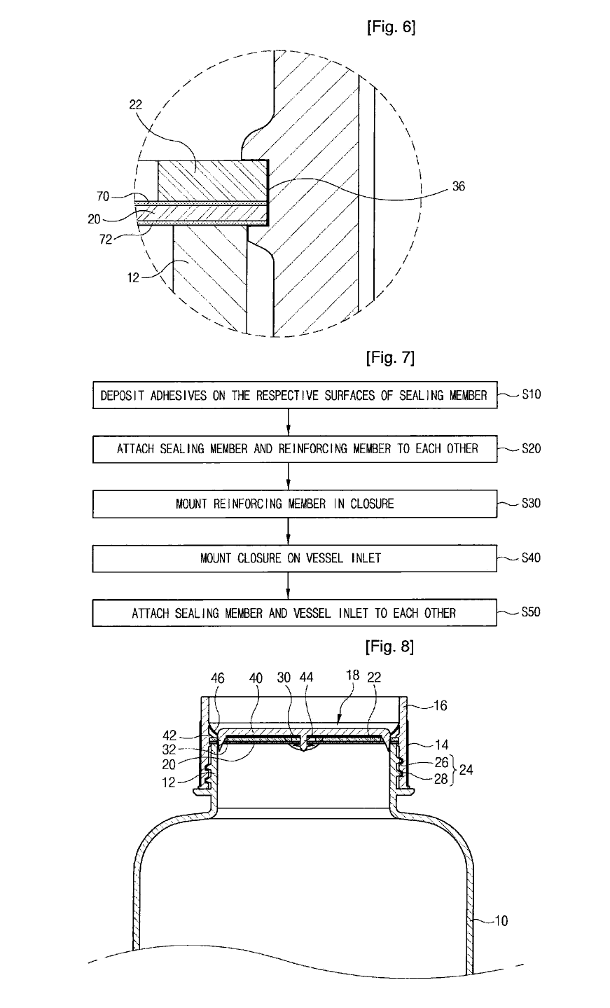

As shown in FIG. 6, adhesive 70 attaching the sealing member 20 to the reinforcing member 22 is deposited on one surface of the sealing member 20, and adhesive 72 attaching the sealing member 20 to an upper surface of the vessel inlet 12 is deposited on the other surface of the sealing member 20. The adhesives 70 and 72 are melted at different temperatures.

A melting temperature of the adhesive 70 deposited on one surface of the sealing member 20 is lower than that of the adhesive 72 deposited on the other surface of the sealing member 20. For instance, when the melting temperature of the adhesive 70 is set to be approximately 120° C., the melting temperature of the adhesive 72 is set to be approximately 180° C.

The adhesives 70 and 72 have different melting temperatures from each other for the sake of an attaching order of the sealing member 20. The adhesives 70 and 72 are deposited on the respective surfaces of the sealing member 20, then the sealing member 20 is attached to the reinforcing member 22, and then the sealing member 20 is attached to the vessel inlet 12. When the sealing member 20 and the reinforcing member 22 are attached to each other by heating, the adhesive 72 deposited on the other surface of the sealing member 20 must not be melted. Accordingly, the adhesives 70 and 72 deposited on the respective surfaces of the sealing member require different melting temperatures from each other.

A process for mounting the closure manufactured by an induction process on the vessel will be explained.

FIG. 7 is a flow chart showing a process for manufacturing a closure of a vessel according to the present invention.

The adhesives 70 and 72 having different melting temperatures from each other are deposited on the respective surfaces of the sealing member 20 (S10). Then, the reinforcing member 22 is pressurized on one surface of the sealing member 20, and is heated at a low temperature (approximately 120° C.). Accordingly, the adhesive 70 having a relatively lower melting temperature is melted, thereby attaching the sealing member 20 and the reinforcing member 22 to each other (S20).

Then, the reinforcing member 22 to which the sealing member 20 has been attached 20 is fitted into the body 16 (S30). Since the reinforcing member 22 is inserted into the locking groove 36 formed at an inner circumferential surface of the body 16, it is prevented from being separated from the body 16.

When the process for mounting the reinforcing member 22 in the body 16 is completed, the closures are stored in a hopper. Then, a next process for mounting the closure on the vessel 10 is performed.

Since the sealing member 20 is stored in the closure kept in the hopper with being mounted onto the reinforcing member 22, the sealing member removing unit 18 is not outwardly exposed. Accordingly, the closures are not interfered with each other, thereby smoothly mounting the closure on the vessel.

When the closures are to be mounted on the vessel inlet 12, the closures are sequentially mounted on the respective vessels under a stored state in the hopper. Herein, the closures are interfered with each other by the sealing member removing unit 18 formed at the closures, and thus are not smoothly mounted on the vessel. Since the locking rod 58 of the locking unit 44 is protruding from the closure in a horizontal direction, the closures are mixed to each other and another closure is locked by the locking rod 58. Accordingly, interference between the closures is caused.

Since the reinforcing member to which the sealing member has been attached is mounted in the body 16, the sealing member removing unit 18 disposed in the body 16 is not outwardly exposed thus to prevent interference between the closures.

When the closure moves along a line at the time of the mounting process thereby to be positioned at an upper side of the vessel in which stuff is stored, the closure is mounted at the vessel inlet 12 by a jig (S40). That is, when the jig rotates the closure at the vessel inlet 12, the female screw portion 28 formed at the body 16 is screw-coupled to the male screw portion 26 formed at the vessel inlet 12 thereby to be coupled to the vessel inlet 12.

The sealing member 20 is stored in the closure with an adhered state to an upper surface of the vessel inlet 12. When the vessel having the mounted closure thereon passes through a tunnel where a high frequency is generated, the adhesive 72 deposited on the other surface of the sealing member 20 and having a high melting temperature (approximately 180° C.) is melted. As the result, the sealing member 20 and an upper surface of the vessel inlet 12 are attached to each other, thereby completing the process for mounting the closure at the vessel inlet 12 (S50).

The operation of the closure of the vessel manufactured by an induction process will be explained.

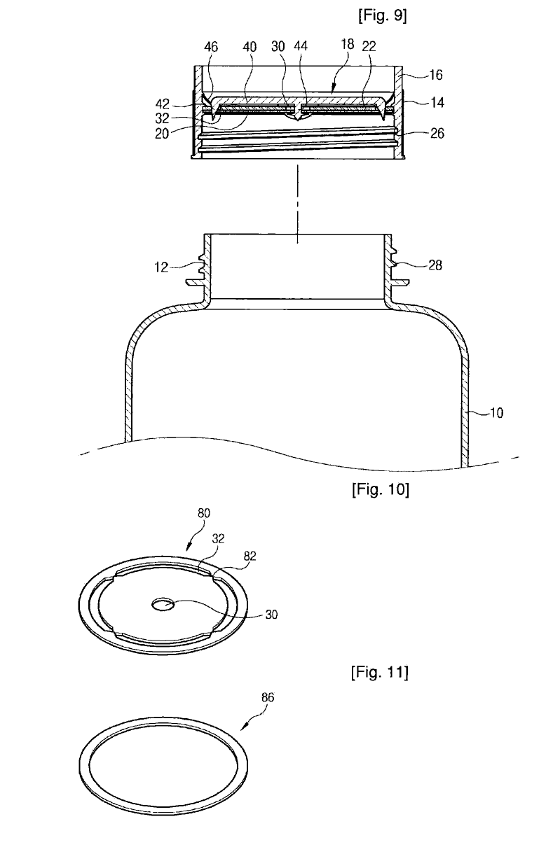

FIGS. 8 and 9 are views showing an operation state of the closure of a vessel according to the present invention.

When the pressing plate 40 is downwardly pressed so as to discharge stuff stored in the vessel 10 outwardly, the connecting unit 46 is elastically transformed and thus the pressing plate 40 is downwardly moved. Then, the cutters 42 formed at an edge of a lower surface of the pressing plate 40 pass through the second through holes 32 of the reinforcing member 22. Accordingly, the first cutting portion 52 of the cutters 42 penetrates the edge of the sealing member 20. At the same time, the locking unit 44 formed at the center of a lower surface of the pressing plate 40 passes through the first through hole 30 of the reinforcing member 22, and the supporting rod 56 of the locking unit 44 penetrates the center of the sealing member 20.

The locking rod 58 of the locking unit 44 penetrates the sealing member 20 through a hole formed by the punch portion 60 with an upwardly bent state. When the locking rod 58 penetrates the sealing member 20, it is elastically restored to the original state thus to be positioned at an inner surface of the sealing member 20 with a straightened state.

Then, when the body 16 is rotated in an open direction, the second cutting portion 54 of the cutter 42 cuts the sealing member 20 as a circular shape, and cuts a connection portion between the first through holes 32 of the reinforcing member.

When the body 16 is separated from the vessel inlet 12, the sealing member 20 and the reinforcing member that have been separated from the vessel inlet 12 are stored in the body 16 since they are locked by the locking rod 58 of the locking unit 44.

FIG. 10 is a perspective view showing a reinforcing member according to a second embodiment of the present invention.

A reinforcing member 80 according to the second embodiment is the same as the reinforcing member 22 according to the first embodiment except a notch portion 82. The notch portion 82 is formed to have a narrow area at a connection portion between the first through holes 32. That is, when the reinforcing member 80 is to be cut by the cutter 42, the notch portion 82 having a narrow area is cut thereby to facilitate the cutting.

FIG. 11 is a perspective view showing a reinforcing member according to a third embodiment of the present invention.

A reinforcing member 86 according to the third embodiment is formed to have a circular ring shape of a certain width, and is attached to an edge of the sealing member 20 by an adhesive. Since the reinforcing member 86 is attached only to the edge of the sealing member 20, it need not be cut by the cutter at the time of cutting the sealing member 20. Accordingly, cutting of the sealing member 20 is more facilitated.

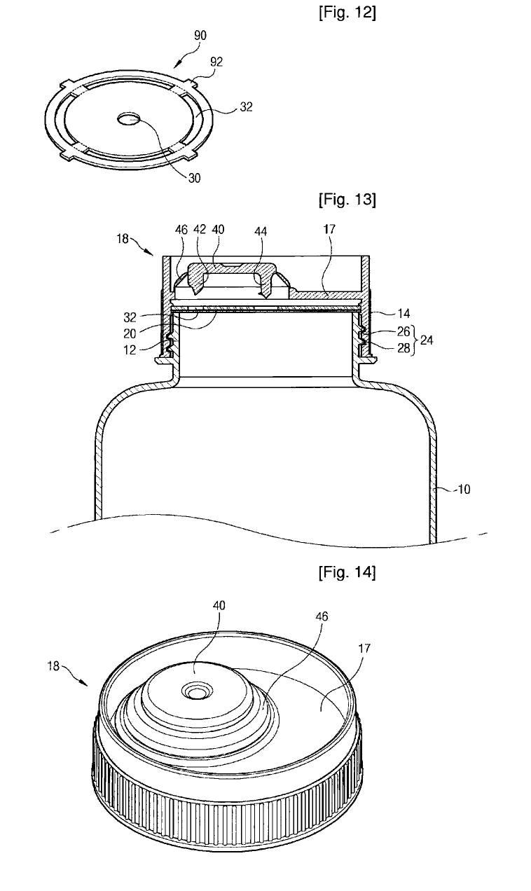

FIG. 12 is a perspective view showing a reinforcing member according to a fourth embodiment of the present invention.

In a reinforcing member 90 according to the fourth embodiment, the first through holes 32 are punched with a certain regular interval therebetween so that a connection portion therebetween can be easily cut by the cutter 42. A locking wing 92 is disposed on an outer circumferential surface of the reinforcing member 90 with the same interval therebetween, thereby preventing the reinforcing member 90 locked in the closure from being separated from the closure.

FIG. 13 is a perspective view showing a closure of a vessel according to another embodiment of the present invention, and FIG. 14 is a sectional view showing the closure of a vessel of FIG. 13. The same components as those of FIG. 2 are endowed with the same reference numerals as those of FIG. 2, and only different construction from that of FIG. 2 will be explained.

The closure of the vessel according to the present invention may have various shapes and structures. As shown in FIGS. 13 and 14, the pressing plate 40 may be formed only at a part of an upper surface 17 of the body of the closure. That is the pressing plate 40 may be formed to be eccentric from the center of the closure. Herein, the locking unit 44 is formed to be positioned at the center of the closure of the vessel.

It will be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A closure of a vessel, comprising:
a body mounted at a vessel inlet through which stuff contained in a vessel is discharged out;
a sealing member removing unit formed in the body, for removing a sealing member sealing the vessel inlet when the body is separated from the vessel inlet, and storing the removed sealing member in the body; and
a reinforcing member having the sealing member attached thereto at the time of an induction manufacturing process, for storing the sealing member in the closure.

2. The closure of a vessel of claim 1, wherein the sealing member removing unit comprises:
a pressing plate disposed in the body, the pressing plate movable in upper and lower directions;
at least one cutter formed at an edge of a lower surface of the pressing plate in a circumferential direction, for penetrating the sealing member when the pressing plate is pressed, and for cutting the sealing member when the body is rotated;
a locking unit downwardly protruding from a lower surface of the pressing plate, for storing the sealing member cut by the cutter in the body; and
a connecting unit connecting an outer circumferential surface of the pressing plate with an inner circumferential surface of the body, and elastically transformed so that the pressing plate may move in upper and lower directions.

3. The closure of a vessel of claim 1, wherein the reinforcing member is formed to have a circular flat shape of a predetermined strength, and the sealing member is attached to the reinforcing member.

4. The closure of a vessel of claim 2, wherein the reinforcing member is formed to have a circular flat shape of a predetermined strength, and comprises:
a first through hole for passing the locking unit at a center thereof; and
second through hole of the same number of the cutters for passing the cutter at a circumference thereof.

5. The closure of a vessel of claim 4, wherein the reinforcing member is provided with a notch portion having a narrow area at a connection portion between the second through holes so as to be easily cut by the cutter.

6. The closure of a vessel of claim 3, wherein the reinforcing member is fittedly coupled to a locking groove formed at an inner circumferential surface of the body.

7. The closure of a vessel of claim 1, wherein the reinforcing member is formed as a circular ring shape, and is attached to an edge of the sealing member.

8. The closure of a vessel of claim 1, wherein adhesive melting at a low temperature is deposited on one surface of the sealing member, and adhesive melting at a high temperature is deposited on the other surface of the sealing member.

9. The closure of a vessel of claim 8, wherein the adhesive deposited on one surface of the sealing member has a melting temperature of 80°˜140°.

10. The closure of a vessel of claim 8, wherein the adhesive deposited on the other surface of the sealing member has a melting temperature of 150° C.˜250° C.

11. The closure of a vessel of claim 8, wherein the adhesive deposited on one surface of the sealing member is attached to the reinforcing member, and the adhesive deposited on the other surface of the sealing member is attached to the vessel inlet.

12. The closure of a vessel of claim 2, wherein the pressing plate is formed at a part of an upper surface of the body.

13. The closure of a vessel of claim 12, wherein the pressing plate is formed to be eccentric from the center of the upper surface of the body.

14. A process for manufacturing a closure of a vessel, comprising:
a first step of depositing adhesives melting at different temperatures on the respective surfaces of a sealing member;
a second step of attaching the sealing member to a reinforcing member at a low temperature;
a third step of mounting the reinforcing member to which the sealing member has been attached in a closure;
a fourth step of mounting the closure at a vessel inlet; and
a fifth step of heating the closure with a high temperature, and thereby attaching the sealing member to the vessel inlet.

15. The process of claim 14, wherein in the first step, adhesive having a melting temperature of approximately 120° C. is deposited on one surface of the sealing member, and an adhesive having a melting temperature of approximately 180° C. is deposited on the other surface of the sealing member.

16. The process of claim 14, wherein in the second step, the reinforcing member is bonded to the adhesive deposited on the sealing member and having a relatively low melting point, and then heated in a low temperature, thereby attaching the reinforcing member and the sealing member to each other.

17. The process of claim 14, wherein in the third step, the reinforcing member to which the sealing member has been attached is fittedly coupled to a locking groove formed in the closure.

18. The process of claim 14, wherein in the fifth step, the sealing member and the vessel inlet are attached to each other, and then are heated in a high temperature, thereby attaching the sealing member to the vessel inlet by the adhesive having a relatively high melting point.
